(19) United States
(12) Patent Application Publication
(10) Pub. No.: US 2026/0111825 A1
(43) Pub. Date: Apr. 23, 2026

(54) SUPPLY CHAIN PLATFORM SYSTEM

(71) Applicants: KABUSHIKI KAISHA TOSHIBA, Minato-ku, Tokyo (JP); TOSHIBA DIGITAL SOLUTIONS CORPORATION, Kawasaki-shi, Kanagawa (JP)

(72) Inventors: Yutaka ASANO, Fuchu Tokyo (JP); Fei PON, Adachi Tokyo (JP)

(73) Assignees: KABUSHIKI KAISHA TOSHIBA, Minato-ku, Tokyo (JP); TOSHIBA DIGITAL SOLUTIONS CORPORATION, Kawasaki-shi, Kanagawa (JP)

(21) Appl. No.: 19/117,663

(22) PCT Filed: Oct. 12, 2023
(86) PCT No.: PCT/JP2023/036953

§ 371 Date: Apr. 2, 2025

(30) Foreign Application Priority Data
Oct. 14, 2022 (JP) 2022-165351
Nov. 21, 2022 (JP) 2022-185619

(51) Int. Cl. G06Q 10/0637; G06Q 10/067

(52) U.S. Cl. CPC G06Q 10/0637; G06Q 10/0672

(57) ABSTRACT

[PROBLEM] To provide a platform on which companies are connected with each other across different supply chains.

[SOLVING MEANS] A supply chain platform system according to embodiments performs user registration processing and registers company information of participating companies. Each participating company is assigned a business partner management group and business partner management information is created for each participating company. The system provides an invitation function of requesting a participating company to enroll in a business partner management group of an own company and an approval function of accepting an enrollment approval in response to the request. The system registers the invited company as a connected company in the business partner management information based on the enrollment approval from the invited company in response to the transmission of the invitation information from a company serving as the inviting company, registers the inviting company as a connected company in the business partner management information based on the enrollment approval to the inviting company in response to reception of the invitation information from an another company serving as the invited company, and creates the supply chain network based on the connected companies.

### TECHNICAL FIELD

Embodiments of the present invention relate to a technique for connecting companies across different supply chains.

### BACKGROUND ART

Supply chain management (SCM) systems and supplier relationship management (SRM) systems can provide centralized management of products from raw material procurement to product manufacturing and sales, and achieve management of relationships among a wide range of suppliers including primary suppliers and secondary suppliers.

The conventional supply chains are managed through “connections” based on trading results, and the chains have a tree structure as described in Patent Document 1. The tree structure of supply chains includes a buyer corresponding to a source at its point of origin and multiple suppliers at points forming the tree to represent a flow of article production (which may include up to article sales).

### PRIOR ART DOCUMENT

### Patent Document

[Patent Document 1] Japanese Patent Laid-Open No. 2015-115016

### DISCLOSURE OF THE INVENTION

### Problems to Be Solved by the Invention

It is an object of the present invention to provide a supply chain platform system capable of creating connections among companies across different supply chains.

### Means for Solving the Problems

A computer system according to an embodiment is a supply chain platform system capable of communication with terminals of companies participating in a supply chain, including: a portal management section configured to perform processing of registering users of the supply chain platform system through the terminal and to register company information of each of the participating companies; a business partner management section configured to assign a business partner management group to each of the participating companies and to create business partner management information for each of the participating companies; an invitation section configured to set one of the participating companies registered in the company information as an invited company, to crate invitation information including a request to the invited company for enrollment in the business partner management group of an inviting company, and to transmit the invitation information to a destination based on the company information; and an approval control section configured to receive an enrollment approval in response to the invitation information from the terminal of the invited company. The business partner management section is configured to register the invited company as a connected company in the business partner management information based on the enrollment approval from the invited company in response to the transmission of the invitation information to a company serving as the inviting company, to register the inviting company as a connected company in the business partner management information based on the enrollment approval to the inviting company in response to reception of the invitation information from an another company serving as the invited company, and to create the supply chain network based on the connected companies.

### BRIEF DESCRIPTION OF THE DRAWINGS

FIG. 1 A diagram showing the network configuration of a supply chain platform system according to Embodiment 1.

FIG. 2 A block diagram showing the functions of the supply chain platform system according to Embodiment 1.

FIG. 3 A flow chart showing a processing flow of user registration, invitation, and approval in the platform according to Embodiment 1.

FIG. 4 A diagram showing an example of a business partner management screen in the supply chain platform system according to Embodiment 1.

FIG. 5 A diagram showing an example of provisional registration of a business partner company using an external company information database according to Embodiment 1.

FIG. 6 A diagram showing examples of a company invitation request screen and a request details screen on which an invited company can perform an approval operation according to Embodiment 1.

FIG. 7 A diagram for explaining a supply chain network diagram according to Embodiment 1.

FIG. 8 A diagram showing an example of a supply chain network diagram of map display type according to Embodiment 1.

FIG. 9 A diagram for explaining how the supply chain network expands according to Embodiment 1.

FIG. 10 A diagram showing examples of an own company disclosure setting screen and an invited company disclosure setting screen according to Embodiment 1.

FIG. 11 A diagram showing an example of a white list registration screen according to Embodiment 1.

FIG. 12 A diagram for explaining information transmission using the supply chain platform system according to Embodiment 1.

FIG. 13 A diagram for explaining the provision of information about the amount of carbon dioxide emissions using the supply chain platform system according to Embodiment 1.

FIG. 14 A block diagram showing the functions of a supply chain platform system according to Embodiment 2.

FIG. 15 A diagram for explaining a first risk management function of the supply chain platform system according to Embodiment 2.

FIG. 16 A diagram for explaining a second risk management function of the supply chain platform system according to Embodiment 2.

### MODE FOR CARRYING OUT THE INVENTION

Embodiments of the present invention are hereinafter described with reference to the accompanying drawings.

Buyers create connections with suppliers constituting supply chains to manage the supply chains. In reality, the connections among the companies forming the respective supply chains are closed within one supply chain management.

The buyers and suppliers are, however, not limited to one supply chain: a buyer in one supply chain trades with suppliers in the other supply chains and a supplier in one supply chain trades with buyers in the other supply chains to have their unique “inter-company connections.” In other words, only a connection of chain or tree shape can be seen from the perspective of each supply chain, but an infinite number of supply chains are present in the form of a large network of multiple inter-company connections.

A supply chain platform system according to the embodiments provides a platform in which companies can engage beyond supply chains. The provision of the platform allows a company to build a supply chain network across different supply chains around the own company placed at the center, and achieves information transmission and information sharing based on the supply chain network.

In each supply chain, a buyer and a supplier have a relationship between a party which purchases materials, parts, and products (hereinafter referred to as “products and others”) and a party which offers the purchased products and others. In a supply chain including a buyer at its point of origin (upstream) and a series of downstream suppliers including primary suppliers and secondary suppliers, one of the primary suppliers that purchases products and others from one of the secondary suppliers is regarded as the buyer of that secondary supplier. In this manner, each company may have both places of the buyer and supplier. This applies to tertiary suppliers linked to secondary suppliers and quaternary suppliers linked to tertiary suppliers.

### Embodiment 1

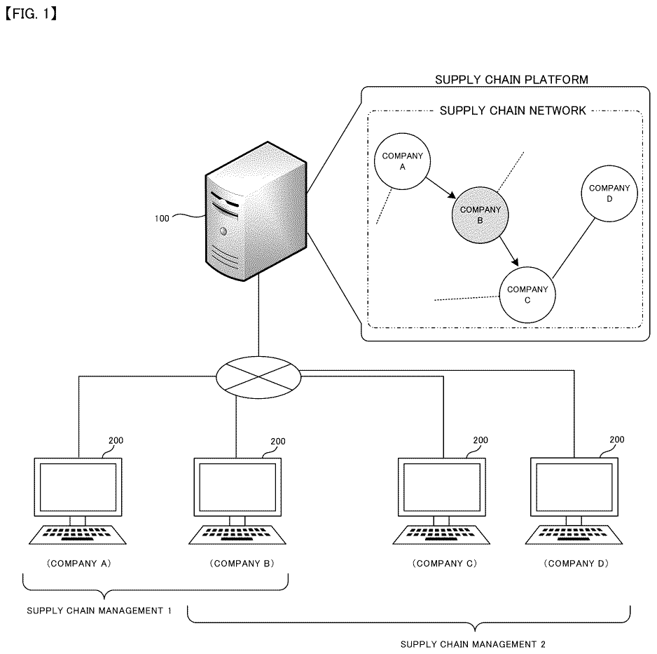

FIGS. 1 to 13 are diagrams for explaining Embodiment 1. FIG. 1 is a diagram showing the network configuration of a supply chain platform system 100 according to Embodiment 1.

To the supply chain platform system 100 (hereinafter referred to as the platform system 100), companies participating in supply chains are connected over the network with their terminals 200. Each company can use various functions provided by the platform system 100 through screens displayed via a browser on the terminal 200.

Each terminal 200 may be a desktop computer, a portable tablet computer, or a laptop computer, and has a data communication function (wireless communication/wired communication) over an Internet Protocol (IP) network or a Mobile Communication Network, a computing function (such as CPU), and a storage device (such as memory and auxiliary storage device). The terminal 200 can include a display control application such as a browser to control display of screens provided by the platform system 100. The terminal 200 may also include a display device (or a touch-panel display device) and input means such as keyboard, as appropriate.

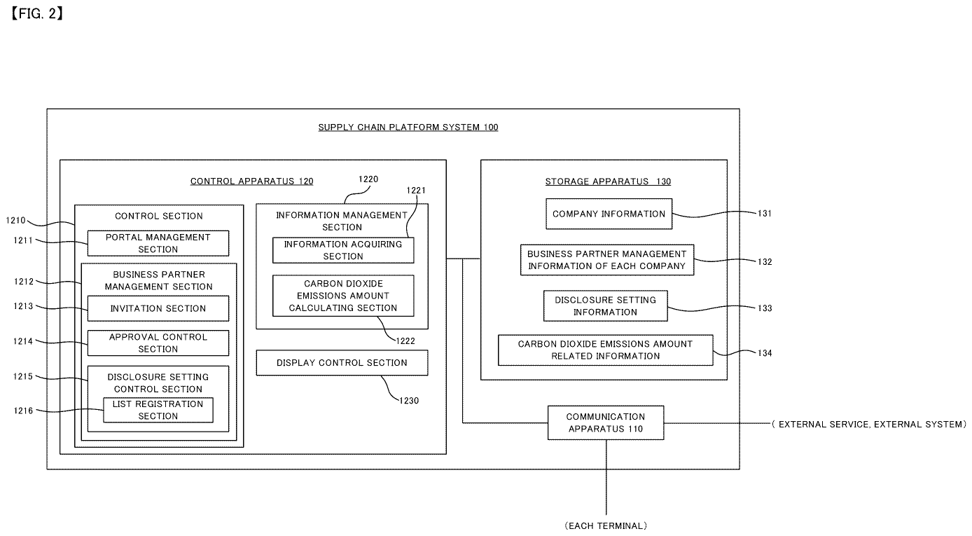

FIG. 2 is a block diagram showing the functions of the platform system 100 according to Embodiment 1. The platform system 100 is a computer system including a communication apparatus 110, a control apparatus 120, and a storage apparatus 130. The platform system 100 can be composed of a single or a plurality of server apparatuses.

The communication apparatus 110 controls data communication with the terminal 200 of each company and controls data communication with an external system (external server). The control apparatus 120 includes a control section 1210, an information management section 1220, and a display control section 1230. The storage apparatus 130 stores various types of information. The display control section 1230 provides screen information on the terminal 200 of each company to control display of screens on the terminal 200 and to control display in response to screen operations on the terminal 200.

The platform system 100 mainly provides the following five functions:
1) a function of managing business partners of a company,
2) a function of inviting a business partner of a company to a business partner management group of that company (including approval by the invited company for enrolling in the group),
3) a function of disclosure setting,
4) a function of visualizing the supply chain network, and
5) a function of information transmission and information sharing (including a function of providing information about the amount of carbon dioxide emissions).

The control section 1210 is a functional section providing mainly the functions 1) to 3), and includes a portal management section 1211, a business partner management section 1212, an invitation section 1213, an approval control section 1214, a disclosure setting control section 1215, and a list registration section 1216.

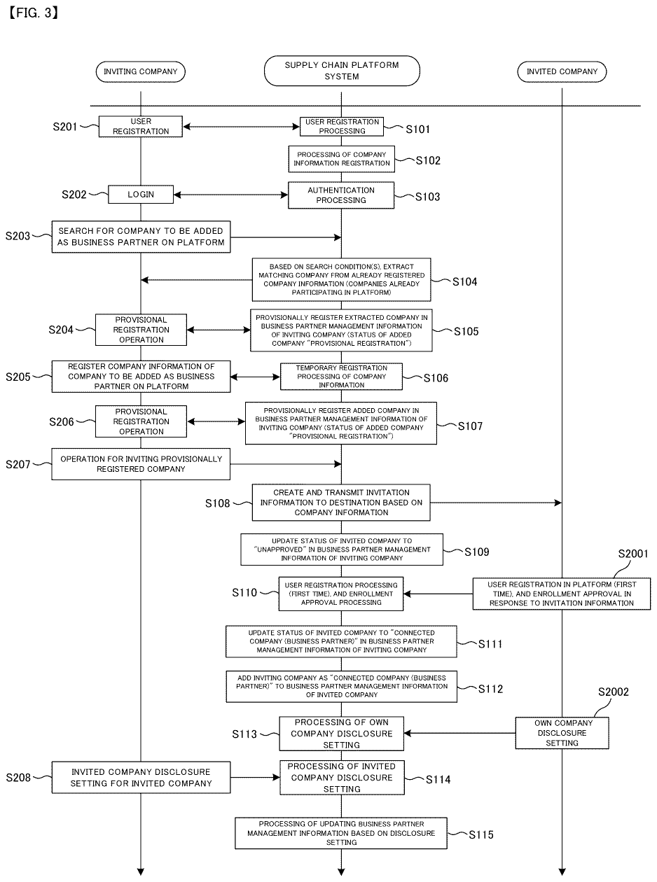

FIG. 3 is a flow chart showing a processing flow of user registration, invitation, and approval in the platform according to Embodiment 1. First, all companies which wish to participate in the platform system 100 perform user registration. Company basic information of each company after the user registration is accumulated in the company information 131. The portal management section 1211 provides a user registration screen and a login authentication screen, not shown, on the terminal 200 of each company and performs user registration processing and login authentication processing through those screens (S101, S102, S201, S103, and S202).

The user registration processing includes accepting inputs of the company basic information such as the corporate number, company name (written in Chinese characters (kanji), rounded Japanese phonetic syllabary (hiragana), angular Japanese phonetic syllabary (katakana), English, and other languages), address, point of contact (telephone number, mail address or the like), country, and region. The portal management section 1211 stores the input information as the company information 131 in the storage apparatus 130. The portal management section 1211 may assign a unique company ID for login authentication, or accept (register) or issue a password for authentication. The information about login authentication of each company can be stored in association with the company information 131 of the company.

The business partner management section 1212 provides a function of managing business partners by setting the companies which have performed user registration as platform participating companies and assigning a business partner management region to each of those companies. The function of managing business partners is a function of managing some of the platform companies (the companies registered in the company information 131) that belong to a business partner management group of an own company and creating the business partner management information 132 of the own company. As later described, the invitation function of Embodiment 1 can invite a company which is not registered in the company information 131. In such a case, a company (invited company) which is not participating in the platform system 100 (not registered formally in the company information 131) can be managed in the business partner management group.

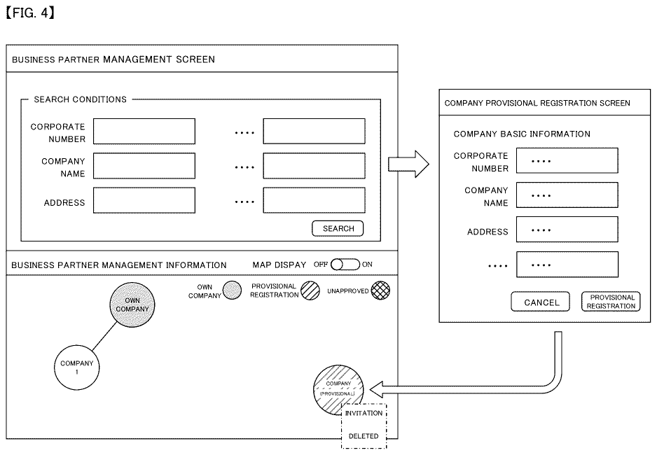

FIG. 4 is a diagram showing an example of a business partner management screen displayed on the terminal 200. The business partner management screen includes a search condition input field corresponding to a search screen and a region for displaying the business partner management information 132. The search screen can provide a function of searching all the companies participating in the platform system 100 registered in the company information 131.

A company participating in the platform invites a business partner which the company wishes to belong to its business partner management group. First, the inviting company can search the companies registered in the company information 131 through the business partner management screen displayed on the terminal 200 and invite any company found in the search. The search condition can accept inputs of multiple search conditions including the corporate number, company name, and address. The business partner management section 1212 receives the search conditions input on the terminal 200 and searches the company information 131 based on the search conditions to extract any company that matches the search conditions (S203, S104).

As illustrated on the right of FIG. 4, the company basic information of the company found in the search is displayed on a company provisional registration screen. The company provisional registration screen includes a provisional registration button and a cancel button. In response to pressing of the provisional registration button, the business partner management section 1212 provisionally registers the company as a business partner to be added in the business partner management information (business partner management group) 132 of the inviting company (S204, S105). As shown in FIG. 4, the provisionally registered company is displayed on the business partner management information 132 of the inviting company (the own company).

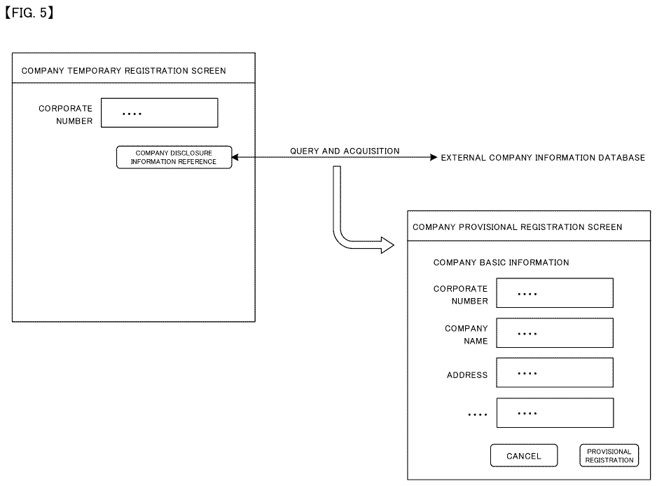

When no matching company is found in the search of the company information 131, the inviting company participating in the platform can temporarily register company information (company basic information) of a company which it wishes to perform provisional registration directly in the platform 100. FIG. 5 is a diagram showing examples of a company temporary registration screen and a company provisional registration screen.

The business partner management section 1212 is linked to an external company information database (for example, the corporate number publication site Of the National Tax Agency https://www.houjin-bangou.nta.go.jp/). When a corporate number is input on the company temporary registration screen and a company disclosure information reference button is pressed, the business partner management section 1212 performs processing of querying the external company information database about company information associated with the input corporate number and acquiring the company information from the external company information database.

The acquired company information is displayed on the terminal 200 through a company provisional registration screen similar to that shown in FIG. 4 (S205, S106). In response to pressing of a provisional registration button, the business partner management section 1212 provisionally registers the company in the business partner management information (business partner management group) 132 of the inviting company participating in the platform (S206, S107). The company which has been temporarily registered is also provisionally registered in the business partner management information 132 of the inviting company participating in the platform, and can be displayed on the business partner management screen similarly to the example shown in FIG. 4.

It should be noted that the query of the external company information database about the company information can be performed by using the company name or address as a keyword in addition to the corporate number, depending on the specifications of the external company information database, for example. While the company temporary registration processing using the external company information database is described by way of example, the inviting company participating in the platform may directly input the corporate number, company name, address, or point of contact of a company to perform temporary registration and then provisionally register that company in the business partner management information 132 of the inviting company.

In the provisional registration processing including the company temporary registration processing, the provisionally registered company has not performed user registration for itself in the platform system 100. Thus, the business partner management section 1212 performs control not to perform registration of the company in the company information 131 at this point.

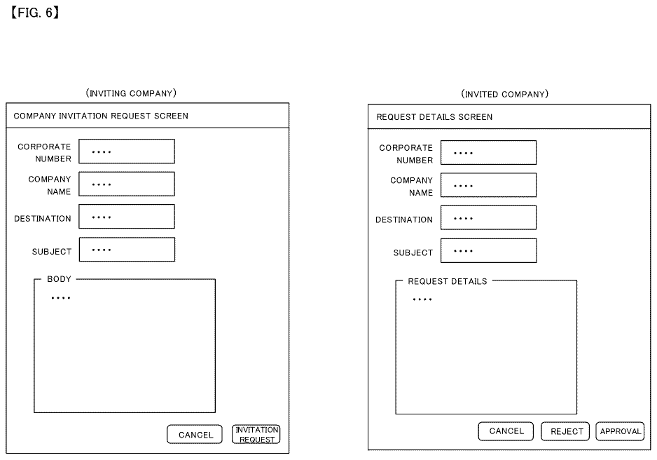

Next, the inviting company participating in the platform invites the provisionally registered company to the business partner management group of the inviting company (the own company). For example, the inviting company can select a company having a “provisionally registered” status registered in the business partner management information 132 in the business partner management screen displayed on the terminal 200 and perform an operation for inviting the company. In response to the invitation operation, the invitation section 1213 provides a company invitation request screen shown in FIG. 6 on the terminal 200. The company invitation request screen includes the company basic information such as the corporate number and company name, as well as other items such as a destination (point of contact), subject, and body. The subject and body can be input and edited by the inviting company participating in the platform (S207). The destination can be controlled to show the mail address registered in the company information 131 by default or can be input directly by the inviting company. The items of the subject and body can be configured to show a prepared template text by default.

The company invitation request screen includes an invitation request button and a cancel button. In response to selection of the invitation request button, the invitation section 1213 creates invitation information with the details of the items on the company invitation request screen. The invitation information can be configured to include the details of the items on the company invitation request screen as well as connection link information (connection URL) to the platform system 100. The invitation section 1213 transmits the created invitation information to the destination (S108). In association with the transmission of the invitation information, the business partner management section 1212 updates the invited company in the business partner management information 132 from the status “provisional registration” to the status “unapproved” (S109).

The invited company receives the invitation information on the terminal 200. The invited company selects the connection link information to the platform system 100 in the invitation information and connects to the platform system 100. The business partner management section 1212 determines whether the invited company requires the company temporary registration processing described above. When the invited company requires the company temporary registration processing, the business partner management section 1212 instructs the portal management section 1211 to perform user registration processing. The portal management section 1211 provides the user registration screen to perform the user registration processing on the terminal 200 (S101 and some other steps). When the business partner management section 1212 determines that the invited company does not require the company temporary registration processing described above, the portal management section 1211 performs login authentication processing (S2001, S110).

After the user registration processing or after the login authentication processing, the approval control section 1214 provides a request details screen shown in FIG. 6 on the terminal 200 of the invited company. The request details screen shows the details of items in the invitation information and includes buttons for approval, rejection, and cancel. In response to pressing of the approval button, the approval control section 1214 performs processing of approving enrollment in the business partner management information 132 of the inviting company and updates the status “unapproved” of the invited company to the status “business partner (connected company)” (S111, S2001).

When the cancel button is selected in the request details screen, the approval control section 1214 performs control to maintain the “unapproved” status of the invited company in the business partner management information 132 of the inviting company at step S111. When the reject button is selected, the approval control section 1214 updates the status of the invited company to the status “approval rejected” in the business partner management information 132 of the inviting company at step S111. In the case of the “approval rejected,” the approval control section 1214 can perform control to remove the invited company from the business partner management information of the inviting company (delete the provisional registration in the business partner management group) after the elapse of a predetermined time period. In addition, the company which has rejected the enrollment approval may be individually managed.

The aspect from the perspective of an own company performing invitation has been described in which the invited company enrolls in the business partner management group of the own company. In the platform system 100 according to Embodiment 1, the own company may be in a position to be invited, and when the own company accepts an invitation from another company, the platform system 100 performs control such that the other inviting company is enrolled in the business partner management group of the own company (the invited company in this case).

Specifically, at step S112 shown in FIG. 3, the business partner management section 1212 adds the inviting company as the business partner (connected company) to the business partner management information 132 of the invited company based on the approval for enrollment of the invited company in response to the invitation information. With this configuration, each company participating in the platform system 100 can constitute the supply chain network around the own company placed at the center both as the inviting company and the invited company.

As described above, the platform system 100 according to Embodiment 1 assigns the business partner management region to each of the companies participating in the platform system 100. The companies participating in the platform system 100 are registered in the company information 131, so that each own company can have the opportunity of inviting another company to the business partner management group of the own company and the opportunity of serving as an invited company and accepting an invitation (enrollment request) from another company to the business partner management group of the other company.

Specifically, the business partner management section 1212 registers the invited company as a connected company in the business partner management information 132 based on the enrollment approval from the invited company in response to transmission of the invitation information to a company serving as the inviting company, and registers the inviting company as a connected company in the business partner management information 132 based on the enrollment approval to the inviting company in response to reception of the invitation information from an another company serving as the invited company, and creates the supply chain network based on the connected companies. As a result, when a company participates in the platform system 100, the supply chain network around the own company placed at the center is constructed even without direct trading experiences with some companies, or across different supply chains.

As described above, a company not participating in the platform system 100 can be invited. The request for enrollment in the business partner management group also serves as a request for participation in the platform system 100, thereby allowing improved opportunities of participating in the platform system 100.

The business partner management function of the platform system 100 performs management by assigning statuses (business partner management statuses) including provisional registration, unapproved, and business partner (connected company) to invitations (enrollment requests) to the business partner management group. The business partner management status is held in the business partner management information 132. In the example of FIG. 4, the objects representing the respective companies are displayed in different display aspects corresponding to the business partner management statuses. For example, display control can be performed such that the object is changed in color, size, shape or the like corresponding to the business partner management status, which facilitates visual recognition of the status of enrollment in the business partner management group.

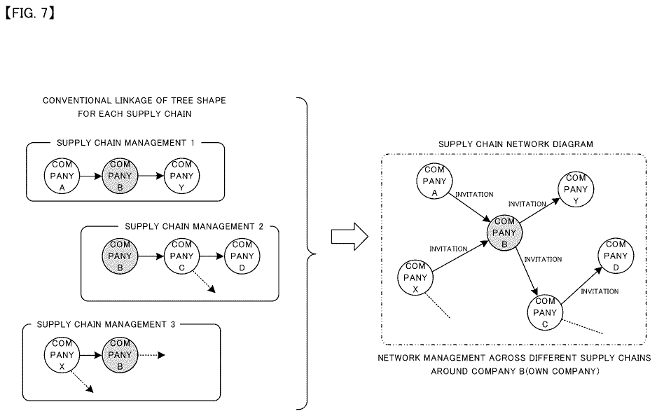

FIG. 7 is a diagram for explaining the supply chain network according to Embodiment 1. As shown in FIG. 7, the conventional supply chain is managed in the shape of a chain or tree representing trade linkages. For example, when a company B belongs to three different supply chain managements, those supply chain management 1, management 2, and management 3 are separately managed. In contrast, the use of and participation in the platform system 100 according to Embodiment 1 allows the company B to manage collectively the supply chain management 1, management 2, and management 3 in the business partner management group of the company B (own company) with a network structure including the company B (own company) placed at the center.

The business partner management group, that is, the business partner management information 132 is, in an aspect, supply chain network information based on the direct invitation relationship between the inviting company and the invited company, and also network information including the company B (own company) at the center and the business partners (connected companies) at the nodes. As later described, the business partner management information 132 has an aspect as supply chain network information including not only the connected companies but also other companies further connected to the connected companies based on the invitation relationship.

The business partner management information 132 can hold the information about the relationship between an own company and its business partners, and for example, can be configured to include the invitation relationship (inviting and invited) with the own company. The information about the supply chain relationship with the own company (buyer, primary supplier, secondary supplier and the like) can be assigned to each company enrolled in the business partner management group and can be included in the business partner management information 132.

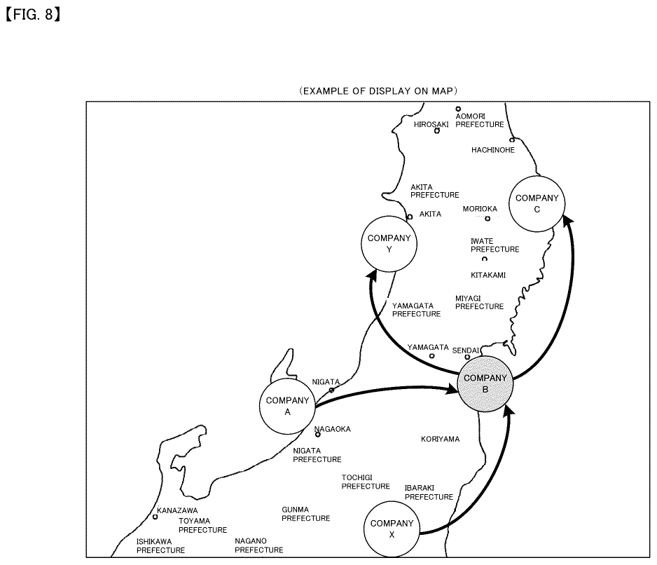

FIG. 8 is a diagram showing an example of a supply chain network diagram of map display type. In the example of FIG. 4, “Map display” can be switched between ON and OFF. When “Map display” is turned ON, the business partners (connected companies) registered in the business partner management information 132 can be displayed on the map based on the address information included in the company information 131.

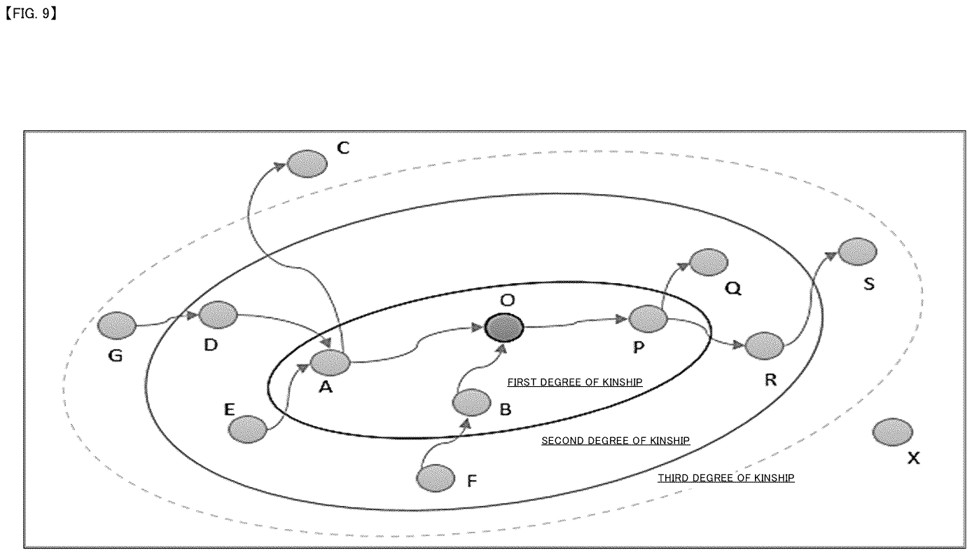

FIG. 9 is a diagram for explaining how the supply chain network expands according to Embodiment 1. The platform system 100 according to Embodiment 1 not only provides a direct invitation relationship but also allows an invited company invited by an own company to serve as an inviting company and invite another company or to be invited by another company. As shown in FIG. 9, the supply chain constituted around a company O placed at the center can visualize the relationship with companies with which the company O is not in a direct invitation relationship.

In the example of FIG. 9, business partners having a direct invitation relationship with the company O serve as network companies of the first degree of kinship, and outside the network company area of the first degree of kinship, network companies of the second degree of kinship are connected, including business partner companies (network companies of the first degree of kinship registered in the business partner management information 132 of the business partners) which have invited or have been invited by the business partners of the first degree of kinship independently of the company O. Outside the network company area of the second degree of kinship, network companies of the third degree of kinship are connected, including business partner companies (network companies of the first degree of kinship registered in the business partner management information 132 of the business partners) which have invited or have been invited independently by the business partners of the second degree of kinship.

In this manner, the business partner management section 1212 can refer to the business partner management information 132 of the connected company registered in the business partner management information 132 of the own company and register the connected company registered in the business partner management information 132 of the connected company as the secondary connected company in the business partner management information 132 of the own company to create the supply chain network including the connected companies having the invitation relationship with the own company based on the invitation information and the secondary connected companies (not connected to the own company but an another company connected to the business partners registered in the business partner management information 132) having the invitation relationship based on the invitation information created by the connected companies independently of the own company.

The business partner management section 1212 performs control such that the business partner management information 132 includes the business partners (connected companies) registered through the invitation function as well as the other business partners (secondary connected companies) connected to the business partners. For example, at the time of registration (addition) of any business partner to the business partner management information 132 of the own through the invitation function, the business partner management section 1212 can perform control to refer to the business partner management information 132 of the business partner and add (register) another business partner registered through the invitation function to the business partner management information 132 of the own company. Since the connection chain expands infinitely in theory, the business partners to be added to the business partner management information 132 of the own company may be controlled, for example by previously setting the range of the business partners up to the second or three degree of kinship.

The display control section 1230 can provide the function of visualizing the supply chain network by creating and providing the supply chain network diagram as shown in FIGS. 7 and 9 on the terminal 200 of the participating company. The display control section 1230 can create, based on the business partner management information 132, a first display object representing an own company, a second display object representing a connected company of the own company, and a line segment connecting the first display object with the second display object to create the supply chain network diagram. In the example of FIG. 9, the company 0 corresponds to the own company and is displayed by the first display object, and connected companies A, B, and P of the company O are displayed by the second display objects of the first degree of kinship.

The display control section 1230 can also create, based on the business partner management information 132, a third display object representing a secondary connected company and a line segment connecting the second display object with the third display object, place the second display object around the first display object, and place the third display object outside the second display object to create the supply chain network diagram. In the example of FIG. 9, the secondary connected companies of the company O are companies D, E, F, R, and Q, and those companies are displayed by the third display objects as the companies of the second degree of kinship belonging to the company O.

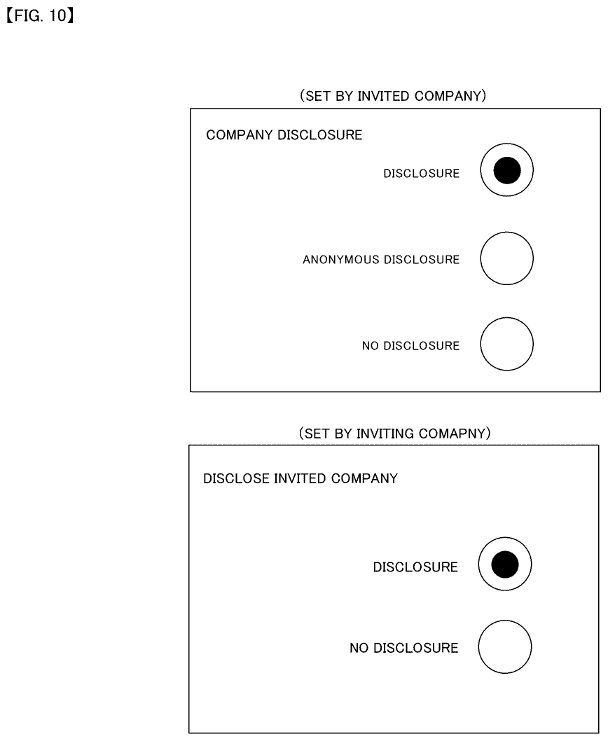

The system can be configured to have the disclosure setting function of setting whether or not an own company should be disclosed to a company other than the business partners having the direct invitation relationship with the own company (other than the companies of the first degree of kinship) . FIG. 10 is a diagram showing examples of an own company disclosure setting screen and an invited company disclosure setting screen.

The disclosure setting function according to Embodiment 1 includes two functions: an own company disclosure setting function and an invited company disclosure setting function. The company disclosure setting function is a function set by the invited company itself to set whether or not the invited company can be disclosed to the companies participating in the platform system 100 other than the inviting company. As shown in FIG. 10, the own company disclosure setting screen includes options of disclosure, anonymous disclosure, and non-disclosure. The anonymous disclosure is an aspect in which company basic information is concealed and only a network node (only the presence thereof) showing a connection is anonymously disclosed. As shown in FIG. 3, the disclosure setting control section 1215 provides the own company disclosure setting screen on the terminal 200 of the invited company which has received invitation information and approved enrollment. The disclosure setting control section 1215 receives one of the disclosure setting statues, that is, the disclosure, anonymous disclosure, or non-disclosure, selected on the own company disclosure setting screen, and stores the received disclosure setting status associated with the invited business partner company in the business partner management information 132 of the inviting company (S2002, S113).

The invited company disclosure setting function is a function set by the inviting company to set the invited company not to be disclosed to the other companies participating in the platform system 100. Since the inviting company and the invited company are in a direct invitation relationship, the invited company disclosure setting function may be referred to as a primary business partner (primary supplier) disclosure setting function, for example. The invited company disclosure setting screen includes options of disclosure and non-disclosure. As shown in FIG. 3, the disclosure setting control section 1215 provides the invited company disclosure setting screen on the terminal 200 of the inviting company. The disclosure setting control section 1215 receives one of the invited company disclosure setting statues, that is, the disclosure or non-disclosure, selected on the invited company disclosure setting screen, and stores the received invited company disclosure setting status associated with the invited business partner company in the business partner management information 132 of the inviting company (S208, S114).

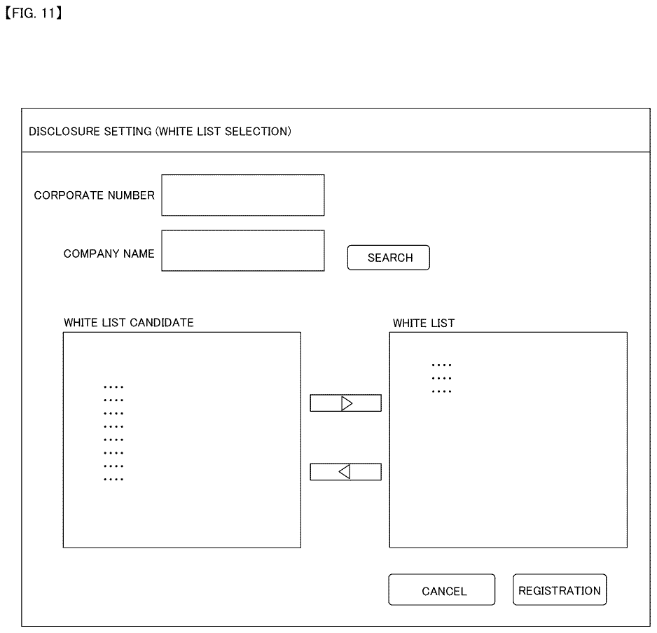

FIG. 11 is a diagram showing an example of a white list registration screen. The disclosure settings on the own company disclosure setting screen and the invited company disclosure setting screen shown in FIG. 10 can have effects on the entire platform system 100. Alternatively, the control may be performed to allow disclosure to some specified companies. To this end, the disclosure setting function according to Embodiment 1 can be configured to include a disclosure setting function based on a white list.

For example, instead of the own company disclosure setting screen shown in FIG. 10, the list registration section 1216 can provide the white list registration screen shown in FIG. 11 on the terminal 200 of the invited company. The list registration section 1216 provides the function of searching the company information 131 on the white list registration screen and displays any company searched for in a field for displaying white list candidates. In response to operation on the terminal 200, the list registration section 1216 performs control to add any of the white list candidates to the white list and to remove any of the white list candidates from the white list. The list registration section 1216 stores the white list registration information associated with the invited company in the business partner management information 132 of the inviting company.

The similar operation is performed in the invited company disclosure setting. The list registration section 1216 provides the white list registration screen on the terminal 200 of the inviting company to control the white list registration and stores the white list registration information associated with the invited company in the business partner management information 132 of the inviting company.

While the white list scheme (specified company disclosure scheme) has been described by way of example, the disclosure setting function of a specified company non-disclosure scheme may be provided. In such a case, instead of the own company disclosure setting information shown in FIG. 10, the list registration section 1216 can provide a non-disclosure company registration screen, not shown, on the terminal 200 of the invited company. The list registration section 1216 provides the function of searching the company information 131 on the non-disclosure company registration screen and displays any company searched for in a field for displaying non-disclosure company candidates. In response to operation on the terminal 200, the list registration section 1216 performs control to add any of the non-disclosure company candidates to the non-disclosure company list and to remove any of the non-disclosure company candidates from the non-disclosure company list. The list registration section 1216 stores the non-disclosure company list registration information associated with the invited company in the business partner management information 132 of the inviting company. The similar operation is performed in the invited company disclosure setting. The list registration section 1216 provides the non-disclosure company registration screen on the terminal 200 of the inviting company to control the non-disclosure company registration and stores the non-disclosure company list registration information associated with the invited company in the business partner management information 132 of the inviting company.

The disclosure setting described above including the white list can be reflected in the business partner management information 132. As described above, the business partner management information 132 of the own company includes the business partners (connected companies) registered through the invitation function as well as the other business partners (secondary connected companies) connected with the business partners. The disclosure setting can be used to perform control such that any secondary connected company that has selected non-disclosure is not included in the business partner management information (business partner management group) 132 of the own company. For example, when a business partner is registered (added) in the business partner management information of the own company through the invitation function, the business partner management section 1212 refers to the business partner management section 132 of the business partner to extract another business partner registered through the invitation function. The business partner management section 1212 refers to the own company disclosure setting of the extracted other business partner, and when the own company disclosure status is non-disclosure, can perform control not to add (register) the business partner to the company business partner management information 132 of the own company. The similar operation is performed in the invited company disclosure setting. For the white list scheme, the business partner management section 1212 can refer to the white list of the secondary connected company, and when the own company is included in the white list, reflect that in the business partner management information 132, and when the own company is not included in the white list, perform control not to reflect that in the business partner management information 132.

The aspect of managing the business partner management information 132 related to the disclosure setting function is summarized as follows.

### Company Disclosure Setting

The disclosure setting control section 1215 performs the own company disclosure setting processing of setting whether or not an own company allows registration of itself as a secondary connected company in the business partner management information 132 of the other companies. The own company disclosure setting status includes disclosure, anonymous disclosure, and non-disclosure.

The business partner management section 1212 stores the own company disclosure setting information associated with the invited company registered in the business partner management information 132 of the inviting company and can perform control such that the invited company having the own company disclosure setting information set to “non-disclosure” is not registered as the second connected company in the business partner management information of the other companies.

### Invited Company Disclosure Setting

The disclosure setting control section 1215 performs the invited company disclosure setting processing of setting whether or not an inviting company allows registration of an invited company as a second connected company in the business partner management information 132 of the other companies. The invited company disclosure setting status includes disclosure and non-disclosure.

The business partner management section 1212 stores the invited company disclosure setting information associated with the invited company registered in the business partner management information 132 of the inviting company and can perform control such that the invited company having the invited company disclosure setting information set to “non-disclosure” is not registered as the second connected company in the business partner management information of the other companies.

### Disclosure Setting of List Scheme

The list registration section 1216 can perform, on the terminal 200, the white list (disclosure company list) registration processing of allowing registration as a secondary connected company in the business partner management information 132 or the non-disclosure company list registration processing of not allowing registration as a secondary company in the business partner management information 132.

The business partner management section 1212 can perform control such that the own company can be registered as the secondary connected company only in the business partner management information 132 of the companies registered in the white list by the invited company or perform control such that the own company is not registered as the secondary connected company only in the business partner management information 132 of the companies registered in the non-disclosure company list by the invited company.

The details of the disclosure setting and the disclosure setting of the list scheme are reflected by the execution of the update processing of the business partner management information 132 at a predetermined time (step 115 in FIG. 3).

As described above, the disclosure allowed or not allowed through the disclosure setting function is reflected in the business partner management information 132. In the processing of creating the supply chain network diagram by the display control section 1230, the company having the setting of non-disclosure in the business partner management information 132 is removed from the supply chain network diagram. This applies to the processing of creating the supply chain network diagram based on the disclosure setting of the list scheme.

The own company disclosure setting and the invited company disclosure setting can be combined and reflected in the business partner management information 132 (supply chain network). For example, in the example of FIG. 7, when an inviting company C has the setting of “disclosure” for an invited company D but the invited company D has the setting of non-disclosure, control can be performed not to reflect the company D as the secondary connected company in the business partner management information 132 of the other company (company B). When the invited company D has the setting of disclosure but the inviting company C has the setting of “non-disclosure” for the invited company D, control can be performed not to reflect the company D as the secondary connected company in the business partner management information 132 of the other company (company B).

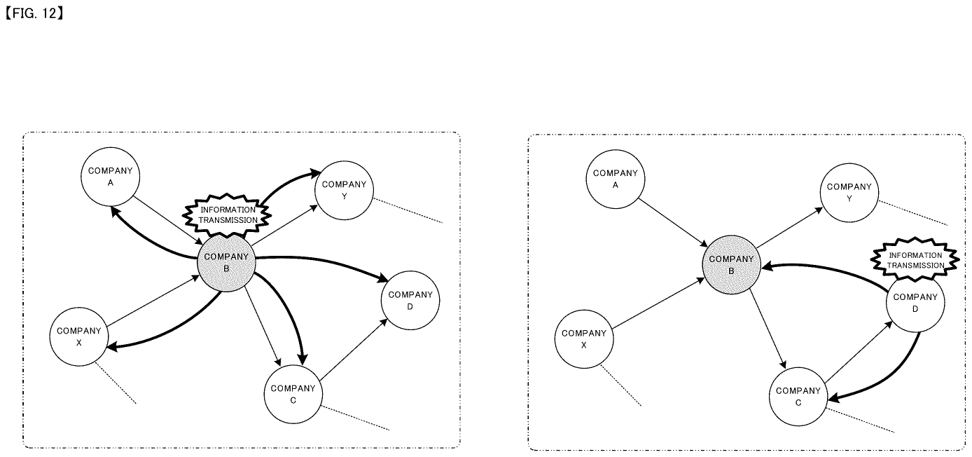

FIG. 12 is a diagram for explaining information transmission using the platform system 100. Companies participating in the platform system 100 can constitute the supply chain network based on the business partner management information 132 and thus utilize the connection of the network as an information transmission route.

As shown on the left of FIG. 12, when the company B transmits information through the platform system 100, the information can be provided at a time for the companies registered as business partners in the business partner management information 132 of the company B. On the right of FIG. 12, when the company D transmits information, and the company C having the company D registered in the business partner management information 132 is registered as the business partner of the company B, the company B can directly receive the information transmitted by the company D through the platform system 100.

The information transmission and information sharing function is performed by the information management section 1220. Specifically, the information management section 1220 can receive, from the terminal 200 of each company participating in the platform, information to be provided for the other companies participating in the platform, and perform control to allow the received information on the platform 100 to be viewed by each company registered as the connected company in the business partner management information 132 or to be provided on the terminals 200.

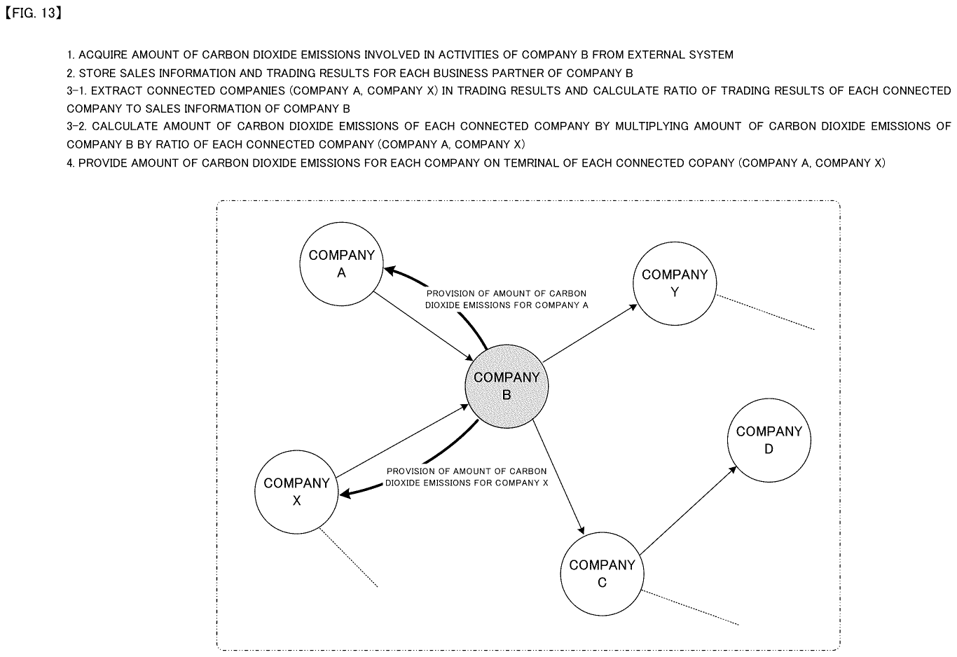

An extension function of the information transmission and information sharing function is the function of providing information about the amount of carbon dioxide emissions. FIG. 13 is a diagram for explaining the provision of information about the amount of carbon dioxide emissions using the platform system 100.

As shown in FIG. 13, an information acquiring section 1221 acquires the amount of carbon dioxide emissions involved in the activities of the company B from an external system and stores the acquired amount in the storage apparatus 130. The external system is an external service which provides information about the amount of carbon dioxide emissions of each company. The information acquiring section 1221 stores sales information and trading results from each business partner of the company B in the storage apparatus 130. The sales information and the trading results from each business partner may be input to the platform system 100 by the company B or may be acquired from a cooperating trading management system used by the company B.

A carbon dioxide emissions amount calculating section 1222 extracts the company A and company X in the trading results for each business partner and calculates the ratio of the trading results of each of the company A and company X to the sales information of the company B. The carbon dioxide emissions amount calculating section 1222 calculates the amount of carbon dioxide emissions by multiplying the amount of carbon dioxide emissions of the company B by the ratio of each of the company A and company X. The information management section 1220 can perform control such that each of the company A and company X can view the amount of carbon dioxide emissions relative to the company B on the platform system 100 or provide the amount of carbon dioxide emissions on the terminal 200 of each of the company A and company x.

It should be noted that the information transmission and information sharing function can be controlled in cooperation with the disclosure setting function described above. Specifically, when any connected business partner of the second or higher degree of kinship has the setting of non-disclosure, control can be performed such that information transmission to and from and information sharing with that business partner are not performed.

While Embodiment 1 has been described, the company information 131 on the platform system 100 includes not only companies invited by an own company but also companies invited by another company, as well as companies which voluntarily have performed user registration to participate in the platform system 100, not limited to those having the invitation relationship. In other words, the platform system 100 can centrally manage the supply chain based on the business partner management group to which the companies not in the invitation relationship with the own company and voluntarily participating in the platform system 100 are assigned. Thus, the own company can separately invite any company invited by another company or any company voluntarily participating in the platform system 100, and for example, can newly add any company other than the supply chain related companies to the business partner management group as a connected company of the own company through the platform system 100. Consequently, it is possible to provide a field of inter-company contact beyond the supply chain management of the own company, that is, a platform capable of constituting the inter-company connection spanning the supply chain management of the own company and the supply chain management of the other companies.

From a different perspective, both companies participating in the platform system 100 through the invitation function and the companies voluntarily participating in the platform system 100 without the invitation relationship can search the companies stored in the company information 131 for a new business partner and contact the found business partner without being limited to the supply chain management of the own company or the other companies. For example, to distribute or change manufacturing sites for risk hedging or higher efficiency, each company can use the platform system 100 to search for a new business partner and make a business offer, or accept a business offer as an invited company from a new business partner. The inter-company communication can be promoted through the platform system 100 beyond the supply chain to which the own company belongs. The own company can make a business offer as described above to a company not stored in the company information 131.

Referring back to the example of FIG. 7, the company A has no relationship with the supply chain management 2 or 3 managed by another company. In the platform system 100, however, the company A can invite the company C in the supply chain management 2 or can be invited by the company C to enroll the company C in the business partner management group of the company A. When the company C in the supply chain management 2 has the setting of disclosure “allowed” as the secondary connected company, the company C automatically belongs to the business partner management group of the company A. In this manner, the platform system 100 allows the own company to have the opportunity of having the connection with the company in the supply chain to which the own company does not belong, in addition to the different supply chains to which the own company belongs.

The own company disclosure setting function and the invited company disclosure setting function described above can be configured to include not only the disclosure (including anonymous disclosure)/non-disclosure within the supply chain to which the own company belongs but also the disclosure (including anonymous disclosure)/non-disclosure to the supply chain to which the own company does not belong.

In the example of FIG. 9, for example when the supply chain composed of the company A and the company E is different from the supply chain composed of the company (own company) O and the company A, the company (own company) O can have the connection with the company E in the supply chain network of the own company on the platform system 100 according to Embodiment 1. The own company can have the opportunity of communication with the company outside the supply chain management of the own company through the platform system 100 according to Embodiment 1.

The function of invitation (including the approval for enrollment of the invited company) to the business partner management group of the own company in the platform system 100 is also an invitation function of asking enrollment in the platform system 100. The platform system 100 can be configured to have the function of invitation to the platform system 100 separately from the function of invitation to the business partner management group. For example, the portal management section 1211 can transmit information for invitation to the platform system 100 instead of the business partner management group to the terminal 200 of the company searched for in the company information 131. Upon reception of the information for invitation to the platform system 100, the company can perform the user registration described above (can be registered in the company information 131) on the terminal 200 to use the various functions provided by the platform system 100.

### Embodiment 2

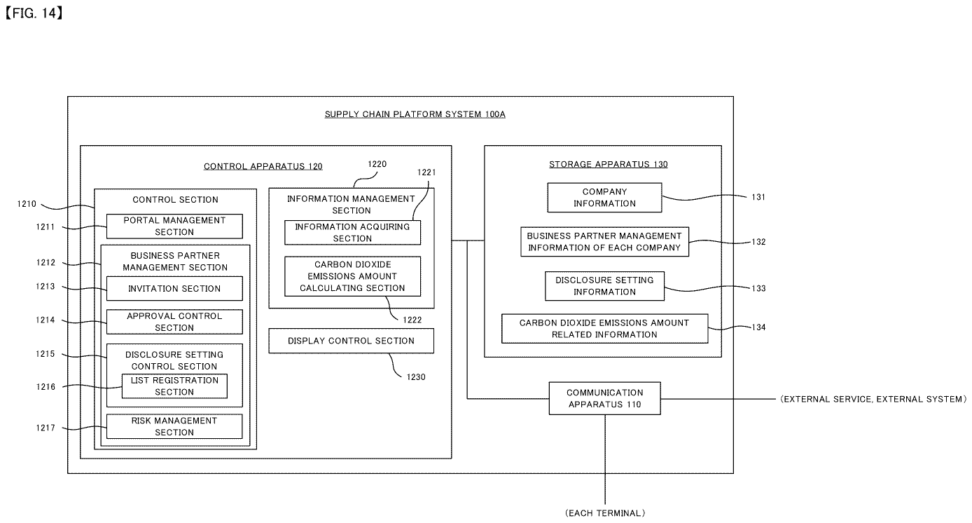

FIGS. 14 to 16 are diagrams for explaining Embodiment 2. Embodiment 2 has a risk management function in addition to the main five functions described above in Embodiment 1. FIG. 14 is a block diagram showing s the functions of a supply chain platform system 100A according to Embodiment 2. The business partner management section 1212 includes a risk management section 1217. The other functions are similar to those in Embodiment 1 described above and are designated with the same reference numerals and description thereof is omitted. In the following, differences between Embodiment 1 and Embodiment 2 are mainly described.

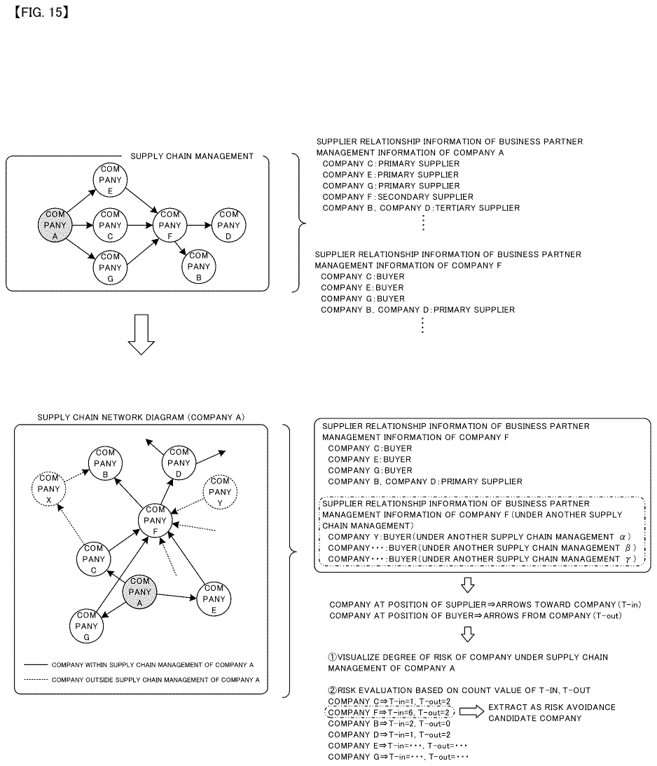

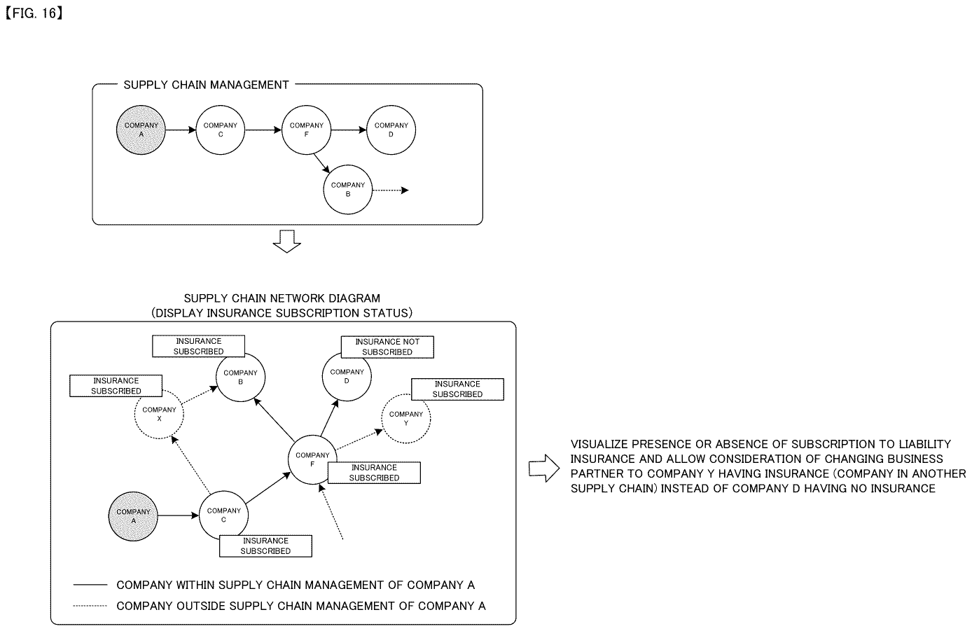

Embodiment 2 provides two risk management functions. FIG. 15 is a diagram for explaining a first risk management function, and FIG. 16 is a diagram for explaining a second risk management function.

The first risk management function is configured to perform risk evaluation based on the connections in a supply chain platform.

As shown in FIG. 15, companies within supply chain management are connected with each other in a buyer-supplier relationship and can also be observed in a conventional supply chain relationship diagram of chain or tree shape. In supply chain management from the perspective of a company A, primary suppliers are a company C, a company E, and a company G, and a secondary supplier is a company F. From the perspective of each of the companies C, E, and G, the company F is a primary supplier. From the perspective of the company F, the three companies including the companies C, E, and G are buyers.

As also seen from the conventional supply chain relationship diagram of chain or tree shape, the company F is relied on by many companies as a supplier of not only the company C, but company E, and company G. If such a company relied on by many companies encounters trouble (such as a disaster), the risk of supply stop may arise. For this reason, in the supply chain management, it is conventionally important to evaluate risks in each of the connected companies to consider distributions of manufacturing sites or provision of alternatives for stable supply.

As shown in the example of FIG. 15, however, in the conventional supply chain management, an own company cannot know whether or not a company belonging to the supply chain of the own company does business with a company belonging to a different supply chain, so that the risk evaluation is difficult to perform.

The supply chain platform system 100A according to Embodiment 2 can network and visualize the connected companies across different supply chains as described above. The first risk management function provides the function of performing the risk evaluation by using information of connections among the companies on the supply chain platform system 100A to visualize or quantify the degree of risk of each company within supply chain management.

As described above, the business partner management information 132 can hold the information of the relationship between the own company and the business partner and can be configured to include not only the invitation relationship (inviting or invited) with the own company, but also the information of supply chain relationship with the own company (such as buyer, primary supplier, or secondary supplier) assigned to each company participating in the business partner management group.

Each company refers to a single or multiple supply chain managements to which the own company belongs, inputs on the terminal 200 the supply chain relationship information such as buyer, primary supplier, or secondary supplier representing the relationship with the company registered in the business partner management information 132 of the own company, for each supply chain management. The business partner management section 1212 controls registration of the supply chain relation information from the terminal 200 of each participating company.

With the company F taken as an example, in the supply chain management including the company A at the center, the company F can register the company B and company D as primary suppliers and register the company C, company E, and company G as buyers. When the company F belongs to different supply chains, the supply chain relationship information can be input for each of the supply chain managements. For example, the supply chain relationship information can be registered by setting a company Y as a buyer in a different supply chain management. Similarly, each of the other companies inputs on the terminal 200 the supply chain relationship information representing the relationship with the company for a single supply chain management or each of different supply chain managements and registers the information in the business partner management information 132.

In this manner, the supply chain relationship information added to the business partner management information 132 allows each company to know how many companies the company does business with as a supplier and how many companies the company does business with as a buyer across different supply chains. It can be seen from the example of FIG. 15 that the company F does business with six buyer companies and does business with two supplier companies across different supply chains. The conventional supply chain relationship diagram of chain or tree shape can only show that the company F is a primary supplier of three companies. In contrast, the supply chain platform system 100A according to Embodiment 2 can show that the company F does business with six buyer companies across different supply chains.

This means that the supply risk observable in the conventional supply chain relationship diagram of chain or tree shape is increased if the risk is evaluated across different supply chains. Thus, the system according to Embodiment 2 can evaluate the supply risk which cannot be known only in the supply chain management of the own company. FIG. 15 illustrates the aspect in which the company F is the primary supplier of the three companies C, E, and G in the supply chain management of the company A. For example, when the company F is a primary supplier of the one company C, it can be seen that the supply risk is reduced in the conventional supply chain relationship diagram of chain or tree form, but the supply risk is increased across different supply chain managements.

The display control section 1230 according to Embodiment 2 creates the supply chain network diagram based on the business partner management information and the supply chain relationship information. For example, to create the supply chain network diagram from the perspective of the company A, the display control section 1230 creates display objects representing the own company and the companies (for example, the connected companies and the secondary connected companies) registered in the business partner management information 132 and creates line segments connecting the display objects across different supply chains according to the supply chain relationship information. The display control section 1230 creates the supply chain network diagram including the display objects and the line segments.

The line segments connecting the display objects can be configured as arrows having directions representing the supply chain relationship information for each supply chain. The display control section 1230 refers to the business partner management information 132 of the companies registered in the business partner management information 132 of the company A to extract the supply chain relationship information for each supply chain and can perform control such that the line segments connecting the display objects are drawn as arrows having directions according to the supply chain relationship information of each supply chain.

For example, the supply chain relationship information at least includes a buyer and a supplier, and the line segment corresponds to an arrow pointing from the buyer company toward the supplier company. The display control section 1230 creates, for each supply chain, a line segment as an arrow from one display object representing the position of the buyer company toward another display object and a line segment as an arrow toward one display object representing the position of the supplier company from another display object to create the supply chain network diagram in which the line segments connect the display objects.

As shown in FIG. 15, in the supply chain network diagram from the viewpoint of the company A, the company F belongs to supply chains (α, β, γ) different from the supply chain management of the company A. For each of the different supply chains, the supply chain relationship information is registered in the business partner management information 132. The number of business partners can be known by the number of line segments connected to the company F, and the number of buyer companies and the number of supplier companies can be visually recognized by the directions of the arrows. Thus, the company A can know the visualized degree of risk of each company in the supply chain network diagram to evaluate the risk of each company under management of the supply chain of the company A (own company).

The supply chain network diagram according to Embodiment 2 can perform the risk evaluation and alternative consideration simultaneously. As shown in FIG. 15, it can be seen from the supply chain network diagram across different supply chains that the company B corresponding to a primary supplier of the company F is also a primary supplier of the company X of a different supply chain. This allows the alternative route from the company A to company C, company X, then to company B to be found, and the company X can be selected as an alternative to the company F for the company B. As shown in the example of FIG. 15, the line segment connecting with the company which does not belong to the supply chain management of the company A, that is, which is registered in the business partner management information 132 of the company A but has no supply chain relationship information registered can be displayed in a different aspect from the line segment connecting with the companies having the supply chain relationship information registered.

In the supply chain network diagram according to Embodiment 1, the “connections” across different supply chains are linked by the line segments based on the business partner management information 132. In the supply chain network diagram according to Embodiment 2, the “connections” across different supply chains are visualized based on the supply chain relationship information of the supply chains to which the companies belong.

Next, another aspect of the first risk management function is described. Embodiment 2 includes referring to the business partner management information 132 of each company included in the supply chain network (business partner management information 132), counting the number of companies registered as buyers (T-in) and the number of companies registered as suppliers (T-out), and using them as risk indicators to perform risk evaluation.

Specifically, the risk management section 1217 can refer to the business partner management information 132 of the connected company (including the secondary connected company) registered in the business partner management information 132, count the number of companies registered as supplier companies across different supply chains (in different supply chains) for each of the companies registered in the business partner management information 132, and perform risk evaluation. As shown in FIG. 15, the risk management section 1217 can refer to the business k partner management information 132 of the company C, company E, company G, company F, company B, and company D in the supply chain management, and count and quantify T-in and T-out as risk indicators of the company A.

Any company having a high T-in is a company which is relied on by many buyer companies as described above. The important risk indicator is T-in. A high T-in means that the trades are concentrated on one company. A company having a high T-in can be evaluated to have a high supply risk when a trouble (for example, a disaster) arises. Accordingly, the risk management section 1217 may be configured to count at least T-in and not to count T-out.

For example, the risk management section 1217 can use a preset threshold value to determine whether or not T-in exceeds the threshold value and perform risk evaluation processing to extract any company having T-in exceeding the threshold value (risk avoidance candidate company). The result of the risk evaluation can be provided on the terminal 200 by the display control section 1230.

For example, in the supply chain network diagram including display objects connected by line segments created based on the supply chain relationship information, the display control section 1230 can display the display object of a company having a T-in exceeding the threshold value by adding a specific effect or display a notice message such as “high risk” on the display object. The display control section 1230 may also be configured to directly display T-in on the display object of the company. The display control section 1230 may separately create a list of companies within the supply chain management and display the results of risk evaluation within the list.

Next, the second risk management function is described.

Companies participating in the supply chain may subscribe insurance such as business interruption guarantee insurance and liability insurance. This is part of risk hedging for an own company or other companies when the own company belongs to the supply chain. When a business partner has insurance, it can provide a source of security in case something happens. In addition, the fact that the company has insurance can be provided as a source security for a business partner.

The second risk management function displays the presence or absence of insurance subscription in the supply chain network diagram to provide the insurance subscription status, thereby allowing risk management. The portal management section 1211 can perform control to receive the input of the insurance subscription status (such as insurance subscribed/insurance not subscribed, or the type of insurance) from the terminal 200 of the own company and allows registration of the insurance subscription information in the company information 131 of the own company in the registration processing of the company information 131.

The display control section 1230 refers to the company information 131 of each company registered in the business partner management information 132 to acquire the insurance subscription status in the supply chain network diagram, and as shown in FIG. 16, displays the insurance subscription status such as “insurance subscribed” or “insurance not subscribed” at the display object of each company in the supply chain network diagram.

In the second risk management function, the display control of the insurance subscription status is not limited to the example of FIG. 16, and for example, the display object of the company can be displayed by adding a specific effect assigned to each of the “insurance subscribed” and “insurance not subscribed”.

As shown in FIG. 16, according to the second risk management function of Embodiment 2, the insurance subscription status of the company outside the supply chain management is visualized on the supply chain network diagram in addition to the company within the supply chain management. For example, since the company D within the supply chain network management of the company A does not have insurance, the company A can consider changing the business partner to a company Y having insurance outside the supply chain management of the company A. From the perspective of the company F, similarly, the company F can consider changing the primary supplier company to the company Y since the company D corresponding to the primary supplier does not have insurance.

In a different aspect, the second risk management function according to Embodiment 2 can allow the companies involved in the supply chain such as the company A and the company F to notify the company D of the fact that the company D has no insurance or to advise the company D to subscribe insurance through the supply chain platform system 100A. The company D can have the opportunity of subscribing insurance.

While Embodiment 2 has been described above, the first risk management function can be configured to perform the risk evaluation by taking account of the insurance subscription status in the second risk management function. For example, the risk management section 1217 can extract any company having the insurance subscription status “not subscribed” as a risk avoidance candidate company even when Tin of the company does not exceed the threshold value in the risk evaluation using T-in.

The second risk management function can be applied to Embodiment 1 such that the insurance subscription status is displayed on the supply chain network diagram regardless of the supply chain relationship information.

The functions constituting the supply chain platform system 100, 100A described above can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to achieve the functions of the respective components.

The program may be recorded on a computer readable recording medium and provided for the computer. Examples of the computer readable recording medium include optical disks such as CD-ROMS, phase-change optical disks such as DVD-ROMs, magneto-optical disks such as Magnet-Optical (MO) disks and Mini Disks (MD), magnetic disks such as floppy disks® and removable hard disks, and memory cards such as compact flash®, smart media, SD memory cards, and memory sticks. Hardware apparatuses such as integrated circuits (such as IC chips) designed and configured specifically for the purpose of the present invention are included in the recording medium.

While the exemplary embodiments of the present invention have been described above, the embodiments are only illustrative and are not intended to limit the scope of the present invention. The novel embodiments can be implemented in various other forms, and various omissions, substitutions, and modifications can be made thereto without departing from the spirit or scope of the present invention. These embodiments and variations are encompassed within the spirit or scope of the present invention and within the invention set forth in the claims and the equivalents thereof.

### Description of the Reference Numerals

100, 100A SUPPLY CHAIN PLATFORM SYSTEM
110 COMMUNICATION APPARATUS
120 CONTROL APPARATUS
1210 CONTROL SECTION
1211 PORTAL MANAGEMENT SECTION
1212 BUSINESS PARTNER MANAGEMENT SECTION
1213 INVITATION SECTION
1214 APPROVAL CONTROL SECTION
1215 DISCLOSURE SETTING CONTROL SECTION
1216 LIST REGISTRATION SECTION
1217 RISK MANAGEMENT SECTION
1220 INFORMATION MANAGEMENT SECTION
1221 INFORMATN ACQUIRING SECTION
1222 CARBON DIOXIDE EMISSIONS AMOUNT CALCULATING SECTION
1220 DISPLAY CONTROL SECTION
130 STORAGE APPARATUS
200 TERMINAL

1. A supply chain platform system capable of communication with terminals of companies participating in a supply chain, comprising:
a portal management section configured to perform processing of registering users of the supply chain platform system through the terminal and to register company information of each of the participating companies;
a business partner management section configured to assign a business partner management group to each of the participating companies and to create business partner management information for each of the participating companies;
an invitation section configured to set one of the participating companies registered in the company information as an invited company, to crate invitation information including a request to the invited company for enrollment in the business partner management group of an inviting company, and to transmit the invitation information to a destination based on the company information; and
an approval control section configured to receive an enrollment approval in response to the invitation information from the terminal of the invited company,
wherein the business partner management section is configured to register the invited company as a connected company in the business partner management information based on the enrollment approval from the invited company in response to the transmission of the invitation information to a company serving as the inviting company, to register the inviting company as a connected company in the business partner management information based on the enrollment approval to the inviting company in response to reception of the invitation information from an another company serving as the invited company, and to create the supply chain network based on the connected companies.

2. The supply chain platform system according to claim 1, wherein the business partner management section is configured to refer to the business partner management information of a connected company registered in the business partner management information of an own company, to register a connected company registered in the business partner management information of the connected company as a secondary connected company in the business partner management information of the own company, and to create the supply chain network including the connected company having an invitation relationship based on the invitation information including the own company at the center and the secondary connected company having an invitation relationship based on the invitation information built by the connected company independently of the own company.

3. The supply chain platform system according to claim 2, further comprising an own disclosure setting control section configured to perform own company disclosure setting processing of setting whether or not a company allows itself to be registered as the secondary connected company in the business partner management information of another company,
wherein the own disclosure setting control section is configured to provide an own company disclosure setting screen including options of disclosure, anonymous disclosure, and non-disclosure,
the business partner management section is configured to store own company disclosure setting information associated with the invited company registered in the business partner management information of the inviting company, and
the business partner management section is configured to perform control such that the invited company having the own company disclosure setting information set to non-disclosure is not registered as the secondary connected company in the business partner management information of another company.

4. The supply chain platform system according to claim 2, further comprising a disclosure setting control section configured to perform invited company disclosure setting processing of setting whether or not the inviting company allows the invited company to be registered as the secondary connected company in the business partner management information of another company,
wherein the disclosure setting control section is configured to provide an invited company disclosure setting screen including options of disclosure, anonymous disclosure, and non-disclosure,
the business partner management section is configured to store invited company disclosure setting information associated with the invited company registered in the business partner management information of the inviting company, and
the business partner management section is configured to perform control such that the invited company having the invited company disclosure setting information set to non-disclosure is not registered as the secondary connected company in the business partner management information of another company.

5. The supply chain platform system according to claim 2, further comprising a list registration section configured to perform white list registration processing of allowing registration in the business partner management information as the secondary connected company through the terminal or non-disclosure company list registration processing of not allowing registration in the business partner management information as the secondary connected company,
wherein the business partner management section is configured to perform control such that only a company registered on a whitelist by the invited company can register the own company as the secondary connected company in the business partner management information of another company or to perform control such that only a company registered on a non-disclosure company list by the invited company is not registered the own company as the secondary connected company in the business partner management information of another company.

6. The supply chain platform system according to claim 1, further comprising a display control section configured to create a first display object of the own company, a second display object corresponding to the connected company of the own company, and a line segment connecting the first display object with the second display object, and to create the supply chain network diagram.

7. The supply chain platform system according to claim 2, further comprising a display control section configured to create a first display object of the own company, a second display object corresponding to the connected company of the own company, and a line segment connecting the first display object with the second display object, to create a third display object corresponding to the second connected company and a line segment connecting the second display object with the third display object, and to create the supply chain network diagram in which the second display object is placed around the first display object and the third display object is placed outside the second display object.

8. The supply chain platform system according to claim 6, wherein the display control section is configured to create, based on address information included in the company information, a supply chain network diagram of a map display type in which the display objects are displayed on a map.

9. The supply chain platform system according to claim 1, wherein the business partner management section is configured to provide a business partner management screen on the terminal and has a function of searching the company information based on a search condition input on the business partner management screen,
the business partner management section is configured to add a company searched for through the search function to the business partner management information as a business partner to be added, and
the invitation section is configured to create the invitation information based on an operation for inviting the business partner to be added on the business partner management screen from the terminal and to transmit the invitation information to a destination based on the company information.

10. The supply chain platform system according to claim 9, wherein the business partner management section is configured to provide a company provisional registration screen on the terminal in response to no company found to match the search condition and to provisionally register a company in the business partner management information based on the company information input through the company provisional registration screen,
the invitation section is configured to create the invitation information based on an operation for inviting the provisionally registered company on the business partner management screen from the terminal and to transmit the invitation information to a destination based on the provisionally registered company information, and
the portal management section is configured to perform the user registration processing of the provisionally registered invited company in response to enrollment approval based on the invitation information and to register the company information of the provisionally registered invited company in the supply chain platform system.

11. The supply chain platform system according to claim 1, further comprising an information management section configured to receive information provided from the terminal of a company to each of the other companies and to provide the received information on the terminal of the company registered in the business partner management information.

12. The supply chain platform system according to claim 1, further comprising:
an information acquiring section configured to acquire, from an external system capable of providing an amount of carbon dioxide emissions involved in company activities for each of the companies, the amount of carbon oxide emissions of each of the participating companies;
a storage section configured to store sales information of the participating companies and trading results of the business partners constituting the sales information;
a carbon dioxide emissions amount calculating section configured to extract, based on the business partner management information, the connected companies of the own company related to the trading results, to calculate a ratio of the trading results of each of the extracted connected companies to the sales information, and to calculate the amount of carbon dioxide emissions for each connected company by multiplexing the amount of carbon dioxide emissions by the ratio of each of the connected companies; and
an information management section configured to provide the amount of the carbon dioxide emissions of each of the companies on the terminal of the company registered as the connected company having business with the own company.

13. A non-transitory computer readable medium including a computer executable program comprising instructions executable by a computer capable of communication with terminals of companies participating in a supply chain, wherein the instructions, when executed by the computer, causes the computer to provide:
a first function of performing processing of registering users through the terminal and registering company information of each of the participating companies;
a second function of assigning a business partner management group to each of the participating companies and to create business partner management information for each of the participating companies;
a third function of setting one of the participating companies registered in the company information as an invited company, to crate invitation information including a request to the invited company for enrollment in the business partner management group of an inviting company, and to transmit the invitation information to a destination based on the company information; and
a fourth function of receiving an enrollment approval in response to the invitation information from the terminal of the invited company,
wherein the second function includes registering the invited company as a connected company in the business partner management information based on the enrollment approval from the invited company in response to the transmission of the invitation information to a company serving as the inviting company, registering, the inviting company as a connected company in the business partner management information based on the enrollment approval to the inviting company in response to reception of the invitation information from an another company serving as the invited company, and creating the supply chain network based on the connected companies.

14. The supply chain platform system according to claim 1, wherein the business partner management section is configured to perform control such that each of the participating companies can register, through the terminal, supply chain relationship information with a company registered in the business partner management information for each of a single or a plurality of supply chains to which the own company belongs,
further comprising a display control section configured to create the supply chain network diagram based on the business partner management information and the supply chain relationship information,
wherein the display control section is configured to create a display object representing the own company and a display object representing each of the companies registered in the business partner management information, to create line segments connecting the display objects according to the supply chain relationship information across the different supply chains, and to create the supply chain network diagram including the display objects and the line segments.

15. The supply chain platform system according to claim 14, wherein the display control section is configured to create a display object representing the own company and a display object representing each of the companies registered in the business partner management information, to create line segments as arrows connecting the display objects for each of the supply chains, directions of the arrows representing the supply chain relationship information, and to create the supply chain network diagram including the display objects and the line segments.

16. The supply chain platform system according to claim 15, wherein the supply chain relationship information includes a buyer company and a supplier company,
the line segment corresponds to an arrow pointing from the buyer company toward the supplier company, and
the display control section is configured to create, for each of the supply chains, a line segment as an arrow from one display object representing a position of the buyer company toward another display object and a line segment as an arrow toward one display object representing a position of the supplier company from another display object to create the supply chain network diagram in which the line segments connect the display objects.

17. The supply chain platform system according to claim 14, wherein the company information includes an insurance subscription status, and
the display control section is configured to display the insurance subscription status at the display object in the supply chain network diagram.

18. The supply chain platform system according to claim 1, wherein the business partner management section is configured to perform control such that each of the participating companies can register, through the terminal, supply chain relationship information with a company registered in the business partner management information for each of a single or a plurality of supply chains to which the own company belongs,
further comprising a risk management section configured to refer to the business partner management information of the company registered in the business partner management information and to perform risk evaluation processing based on the supply chain relation information,
wherein the supply chain relationship information includes a buyer company and a supplier company,
the risk management section is configured to count the number of companies registered as the supplier companies across the different supply chains for each of the companies registered in the business partner management information, and to perform the risk evaluation based on the number of the companies registered as the supplier companies.

19. The supply chain platform system according to claim 18, wherein the company information includes an insurance subscription status, and
the risk management section is configured to perform the risk evaluation processing based on the number of the companies registered as the supplier companies and the insurance subscription status.

20. The supply chain platform system according to claim 1, wherein the company information includes an insurance subscription status,
further comprising a display control section configured to create a display object representing the own company and a display object representing each of the companies registered in the business partner management information, to create line segments connecting the display objects, and to create the supply chain network diagram including the display objects and the line segments,
wherein the display control section is configured to perform control to visualize the insurance subscription status of the display object in the supply chain network diagram.
